(19) United States
(12) Patent Application Publication
(10) Pub. No.: US 2012/0061308 A1
(43) Pub. Date: Mar. 15, 2012

(54) ASSEMBLY FORMED BY A FILTRATION MEMBRANE AND A SUPPORT PLATE

(75) Inventors: Morgan Gilet, Caulnes (FR); Géraldine Taine, Auvers Sur Oise (FR)

(73) Assignee: AES CHEMUNEX, Combourg (FR)

(21) Appl. No.: 13/319,785

(22) PCT Filed: May 12, 2010
(86) PCT No.: PCT/EP2010/056567

§ 371 Date: Nov. 10, 2011

(30) Foreign Application Priority Data
May 12, 2009 (FR) 09 53120

(51) Int. Cl. B01D 35/30

(52) U.S. Cl. 210/232; 210/483

(57) ABSTRACT

The present disclosure relates to an assembly formed from a planar rigid filtration membrane and generally flat plate for accommodating and supporting this membrane, to activate and/or reveal immobilized contaminants on the membrane, the support plate comprising a holding and immobilization device cooperating with a periphery of the membrane, wherein the device comprises at least one non-deformable member that projects from the general plane of the plate and at least one stop tab, substantially perpendicular to the plane, which is extended by a holding appendage substantially parallel to the plane, so that the membrane can be engaged with the member only through a first movement of the membrane substantially parallel to the plane of the support followed by a second movement substantially perpendicular to the plane.

### CROSS-REFERENCE TO RELATED APPLICATIONS

This application is a National Phase Entry of International Application No. PCT/EP2010/056567, filed on May 12, 2010, which claims priority to French Patent Application Serial No. 0953120, filed on May 12, 2009, both of which are incorporated by reference herein.

### BACKGROUND AND SUMMARY

The present invention is situated in the field of equipment for the microbiological testing of substances in the liquid phase.

Qualitative or even quantitative analysis of the presence of contaminants such as microorganisms is necessary for performing sterility tests on fluids. Thus the detection and analysis of particles, living or otherwise, contained in liquid or gaseous fluids, food, pharmaceutical, biological, cosmetic or health products, as well as the monitoring of fermentation processes, in general includes a step of depositing particles on a substrate and the optical analysis, for example by scanning, of the surface of this substrate.

The present applicant has developed a technique according to which the particles are retained on a filtration membrane, following which the latter is put in contact with a material able to react with the contaminated particles in order to mark them, so that the marking product reacts with the enzymatic activity of the contaminant, in order to create a fluorescent signal. It then suffices to carry out an analysis, in particular by laser excitation of the membrane, in order to check whether contaminants are present and in what number. Such a technique has widely supplanted the one that consisted of collecting any contaminants, transferring them into a Petri dish and awaiting development thereof in order to perform the appropriate tests.

Use of the aforementioned technique, developed by the present applicant, requires the transfer of the filtration membrane onto a support plate that generally comprises a cellulose element or pad impregnated with a solution for marking the viable microorganisms. When this membrane is placed on the support plate, the problem posed of the possible creation of an air bubble between the membrane and the cellulose pad, this air bubble forming a screen that opposes the correct and complete reaction between the marking product and the microorganisms. To solve this problem, the users are invited to place the membrane on the support plate not in a single action generally directed perpendicular with respect to the support plate, but in an action in two phases comprising firstly putting the periphery of the membrane in contact with the plate and then applying the rest of the membrane against this plate. This “duplicated” manipulation drives out the air present between the membrane and the support thereof.

In practice, many users use this methodology. However, this requires that said operator does not forget to use it. If he forgets, the test performed cannot be accepted as valid since the marking material will not have completely fulfilled its function.

The present invention therefore aims to solve this difficulty by proposing means that make it possible to position a membrane correctly in its support plate so as to prevent the creation of an air bubble between them. Thus a first subject matter of the invention consists of an assembly consisting of a flat rigid filtration membrane, and a generally flat plate, for receiving and supporting this membrane, in particular with a view to the activating and/or revealing of contaminants immobilised thereon, this support plate comprising holding and immobilisation means able to cooperate with the periphery of the membrane. According to the invention, said means comprise at least one non-deformable member that projects above the overall plane of said plate and comprises at least one tab forming a stop, roughly perpendicular to said plane, which is extended by an retaining appendage roughly parallel to said plane, so that said membrane can be engaged with this member only in a first movement of the membrane substantially parallel to the plane of the plate, followed by a second movement substantially perpendicular to said plane.

The presence of at least one non-deformable member constitutes an obstacle that opposes the direct engagement of the membrane on the plate in a movement with a direction roughly perpendicular to the plane thereof. By virtue of the features of the invention, it is therefore only possible to place the membrane on the plate in the aforementioned two movements, so that the operator does not need to be concerned about or remember the operations to be used since the objects that he is manipulating include means that will guide him in performing his manipulations.

The term “membrane” means both a self-supporting membrane and a flexible filtration structure fixed to a rigid frame. The expression “first movement of the membrane substantially parallel to the plane of the plate” means that, when this operation is performed, the membrane occupies a position very close to the plate, parallel thereto or, at the very least, forming with it an acute angle of no more than a few degrees (10° to 15° maximum).

According to other advantageous features of this assembly:

it comprises at least one second member forming a locking member, which also projects above the overall plane of said plate, this member being elastically deformable so that, during said second movement, it retracts and then resumes it initial position, thus locking the membrane;

said non-deformable member is situated opposite to and facing said second member;

said membrane is provided with a lug able to cooperate with said non-deformable member;

said lug is, see from above, in the general shape of a “T”;

said membrane is provided with a lug able to cooperate with said second member;

said lug is, as seen from above, in the overall shape of a Latin or Greek cross;

said membrane fits in a circle, said lug extending radially, at the periphery of this circle;

said plate comprises a region that supports said second member and is separated from the rest of the plate by a mechanical weakening zone, so that, following a mechanical force exerted on this region, it is given a particular orientation with respect to the rest of the plate, which makes it possible to release the membrane from said second member;

said region forms an appendage with respect to the rest of the plate, said weakening zone being situated at the boundary thereof;

said plate has, in the central part thereof, a recess able to accept material suitable for interacting with said membrane.

Other features and advantages of the present invention will emerge from a reading of the following detailed description of a preferential embodiment.

### BRIEF DESCRIPTION OF THE DRAWINGS

This description will be given with reference to the accompanying drawings, in which:

FIGS. 1 and 2 are views in perspective of a receptacle and a base forming a pedestal for this receptacle, these two elements constituting a test device;

FIG. 3 is a view in perspective of the receptacle that appears in FIGS. 1 and 2;

FIG. 4 is a plan view of a membrane constituting the assembly and the device according to the invention;

FIG. 5 is a perspective view of the base able to cooperate with the receptacle in FIG. 3, this base being here provided with a membrane and a sampling cap for the latter;

FIG. 6 is a side view of the cap appearing in FIG. 5;

FIG. 7 is a plan view of the plate of the support constituting the assembly according to the present invention;

FIG. 8 is a perspective view of the plate of FIG. 7;

FIG. 9 is a view in section along the plane IX-IX in FIG. 7 of the support plate, this view being particularly intended to explain the way in which a membrane is placed on this plate; and

FIG. 10 is a plan view similar to FIG. 7, in which the silhouette of the membrane is marked in broken lines.

### DETAILED DESCRIPTION

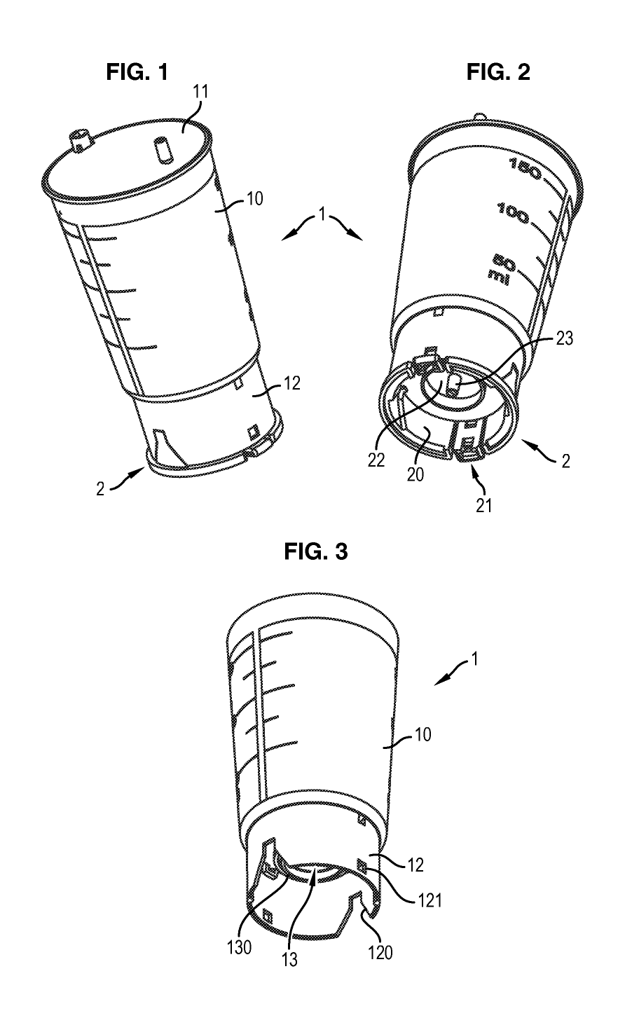

The receptacle 1 and the base 2 shown in the appended FIGS. 1 and 2 form part of a microbiological test device. The receptacle 1 is intended to receive the liquid product that it is proposed to test. It has in some way a dual function of container and funnel.

It comprises a flask 10 made from plastics material, closed by a removable cap 11, which is provided with openings for connection thereof to a pump for example. This container is preferable transparent so that the operator can view the level of liquid that it contains. Its bottom part is referenced 12, in one piece with the flask, and is in the general form of a cylindrical peripheral skirt.

As shown more particularly in FIG. 3, this bottom part is provided with two scallops 120 disposed one facing the other, the function of which will be explained below. It also comprises two openings 121, square in shape, that also face each other. Here also, the function of these openings will be explained below.

As also shown in this FIG. 3, the bottom of the container 10, which connects it with the bottom part 12, is open at its centre in order to form a circular passage 13 the bottom side of which is fitted with a gasket 130. This receptacle 1 is intended to engage with a base 2 forming a pedestal. This base 2 is in the general form of a cylinder and its peripheral external wall is, as shown in FIG. 5, provided with two protrusions 23 intended to engage with the complementary scallops 120 in the bottom part 12 of the receptacle 1.

This pedestal also comprises two tabs 21, elastically deformable, which each carry a finger 210 intended to engage in the openings 121 in the bottom part 12 of the receptacle. These lugs 21 are made in one piece with the pedestal 2. They are directed parallel to the longitudinal axis thereof and are separate from the rest of the pedestal.

Under these conditions, it will be understood that the movement of engagement of the receptacle 1 on the base 2 is guided by the protrusions 23 and scallops 120, while the locking of the receptacle on the base takes place automatically, by ramp effect, via the elastically deformable tabs 21. These two elements are separated by exerting a pressure on the tabs 21 so as to cause them to retract slightly towards the centre and thus release the fingers 210. Although this is not clearly visible in the figures, the pedestal 2 has, parallel to and above a bottom wall 22 provided with a discharge orifice 23, a perforated surface, formed by a network of concentric flutes, which constitute a filtration surface. Such a structure advantageously replaces a sintered glass surface which, up until then, required to be supplemented by the use of a cellulose filter support.

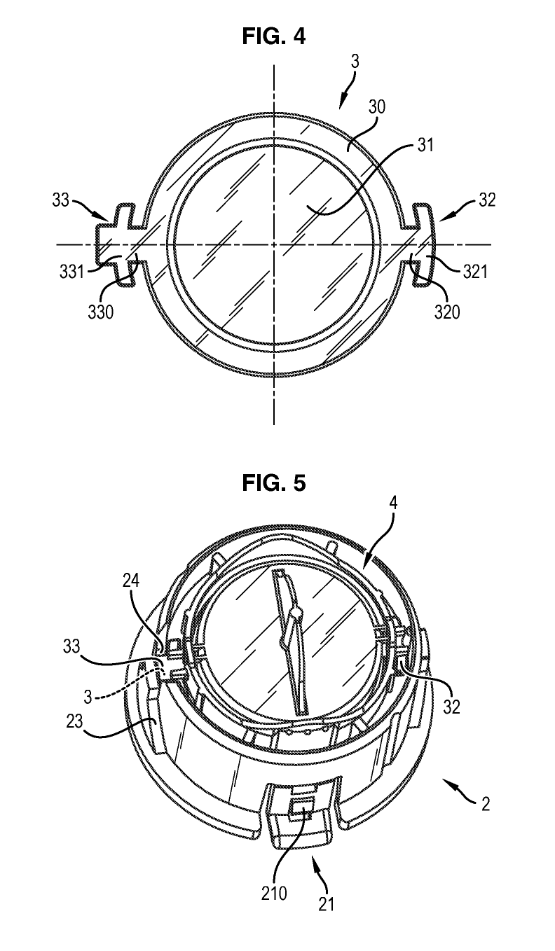

This filtration surface is intended to receive a rigid filtration membrane as shown in FIG. 4. This filtration membrane consists of a filtration structure 31 disposed on a circular-shaped rigid peripheral frame 30. This frame 30 consists for example of a moulded plastics material, while the structure 31 of the membrane is for example based on polyethylene terephthalate with a usual thickness of around 23 micrometres and a porosity variable from 0.1 to a few micrometres.

As shown in this figure, the membrane is provided with two diametrically opposed lugs. They form an integral part of the frame 30 and are made in one piece therewith. They extend in the same plane as the frame 30.

The lug 32 is in the general shape of a “T” with a base 320 that extends in the radial direction, and a slightly curved transverse bar 321, which extends perpendicular to this base. The second lug is in the form of a Latin or Greek cross, with a radial base 330 and a transverse branch 331. The advantage and function of these shapes will be explained below.

This membrane is intended to come to be positioned on the filtration surface of the base 2 described above so that the structure 31 is superimposed on the aforementioned network of concentric flutes. To do this and as shown in FIG. 5, the base 2 comprises a cutout 24 for engaging the lugs 32 and 33 respectively. This cutout forms both an immobilisation means and positive location means.

When the liquid to be tested has been filtered, any contaminants that it contains are retained in the structure 31 of the membrane 3. The test operation next consists of marking and/or revealing these contaminants so as to be able to view them or even count them. To do this, it is necessary to take off the membrane in place on the base 2 in a sterile manner. This is because, in the contrary case, manipulation of the membrane by the operator would bring other types of contaminant.

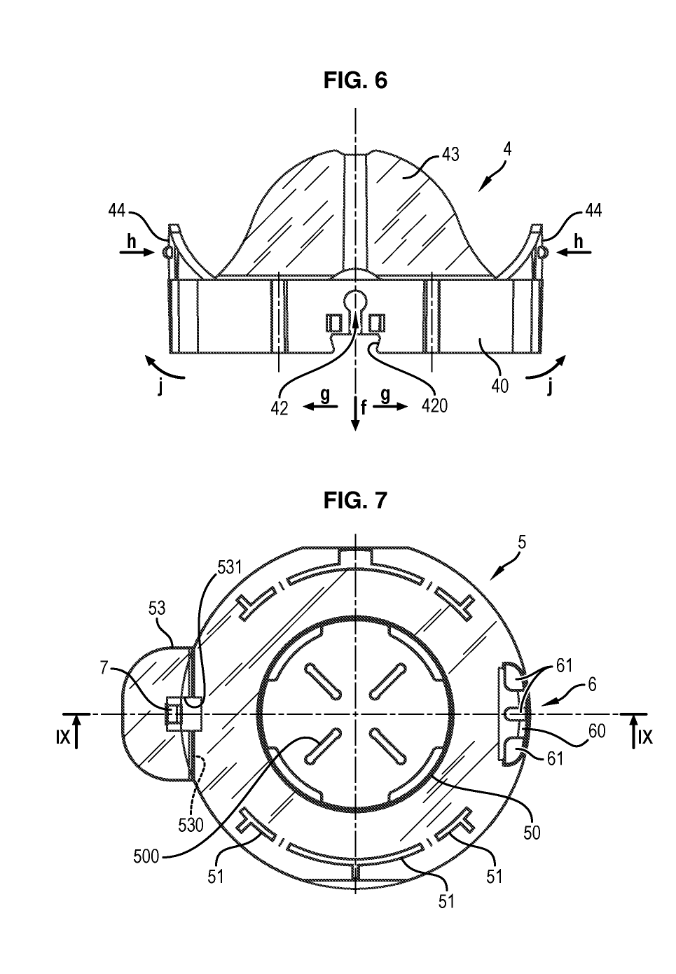

For this purpose, use is made of a takeoff cap 4 that appears in FIGS. 5 and 6. This cap comprises essentially a peripheral cylindrical skirt 4 the outside diameter of which corresponds, to within any clearance, to the outside diameter of the frame 30 of the membrane 3. This peripheral skirt comprises two scallops 41 diametrically opposed to each other, directed parallel to the generatrices of the cylinder constituting the skirt.

Each scallop 41 has a broadened lower part 420 with convergent edges 420. In the state shown in FIG. 6, the separation between the edges 420 is less than the width of the bases 320 and 330 of the lugs 32 and 33 of the membrane. The cap 4 is moreover provided with two diametrically opposed brackets 44 that project upwards, above the skirt 40. They are distant angularly from the scallops 41 by 90°. Moreover, a gripping handle 43 extends perpendicular to the brackets 44.

This cap 4 is intended to engage on the membrane 3 when it is positioned on the pedestal 2. This movement takes place downwards in the direction of the arrow f in FIG. 6 while the scallops 42 are positioned vertically in line with the lugs 32 and 33 facing the bases 320 and 330 thereof.

By pressing on these brackets, the convergent edges 420 separate by elastic deformation and snap elastically onto these lugs so as to be fixed thereto. This separation movement is represented by the arrows g in FIG. 6. To proceed with the reverse manoeuvre, that is to say detaching the membrane 3 from the cap 4, it suffices to exert a pressure on the brackets 44 in the direction of the arrow h, which separates the two opposite parts of the skirt 40 in the direction of the arrow j, and then releases the lugs of the membrane.

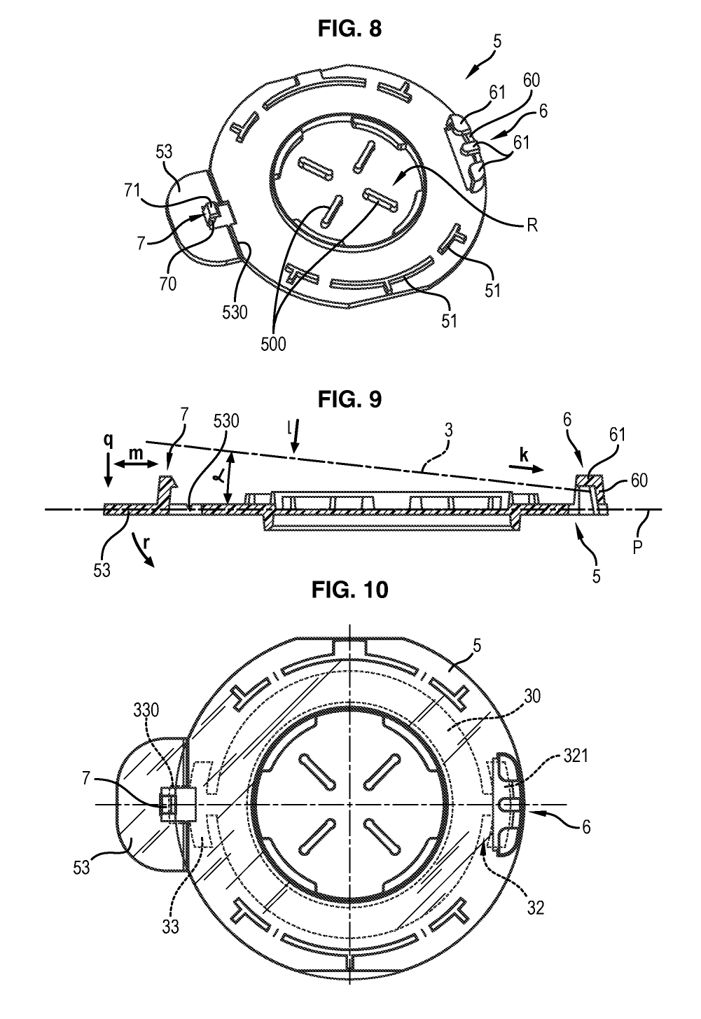

This operation of “releasing” a membrane is performed so as to effect its transfer onto a reception and support plate that appears in particular in FIGS. 7 and 8. This plate is intended to permit the marking and/or revealing of the contaminants carried by the membrane 3.

This solid, that is to say non-perforated, support plate 5 is a plate made from moulded plastics material, generally flat, with a mid-plane referenced P in FIG. 9. This plate is provided with an appendage 53 that is situated in the' aforementioned plane P and is in one piece with the rest of the plate. This appendage 53 comprise, in its area of attachment to the rest of the plate, a mechanical weakening line 530, represented by a groove the function of which will be explained below. The plate has, on its top face, moulded in one piece, a centred circular wall 50 the diameter of which is equal to the inside diameter of the frame 30 of the membrane 3.

Inside the recess R delimited by this wall, elongate-shaped studs 500 are arranged. This recess R is intended to accept a material such as a cellulose pad soaked in a material able to mark or reveal the contaminants carried by the membrane.

The plate 5 also comprises other walls 51, which for their part are formed in portions, which represent the rim of the plate. These walls fit in a circle the diameter of which is slightly greater than the outside diameter of the membrane 3.

The plate 5 comprises means of holding and immobilising the membrane 3. These means comprise a non-deformable member 6, which is positioned opposite and facing the appendage 53. This member 6 consists of a tab 60 forming a stop, which extends from the plate 5 vertically upwards, in a direction roughly perpendicular to the plane P. This lug is extended, parallel to the plane P, by three horizontal appendages 61.

In addition, the aforementioned appendage 53 comprises a second member 7 forming a locking member, which also projects above the overall plane and the plate, this member 7 being elastically deformable. As shown more particularly by FIGS. 8 and 9, this member 7 is in the form of a hook, with a foot 70 perpendicular to said plane P, and a locking finger 71, roughly parallel to this plane P.

The membrane is placed on the support in the following manner. Using the aforementioned cap 4, the lug 32 of the membrane 3 is positioned in a movement substantially parallel to the plane of the plate 5 and represented by the arrow k in FIG. 9. In any event and failing a strictly parallel movement, the axis formed by the membrane 3 and the plan P is an acute angle a, of a few degrees. In doing this, the transverse bar 321 of the lug 32 is engaged inside the non-deformable member 6.

Next, by a movement represented by the arrow 1 and directed substantially perpendicular to the plane P, the rest of the membrane is then engaged so that the second lug 32 elastically deforms the member 7 in the direction of the double arrow m, the finger 71 then coming to be locked on the lug 33. It is clear that, by reason of the non-deformable character of the member 6, any other method of engaging the membrane on the plate is not possible, in particular in a movement perpendicular to the plate. The movement described here makes it possible to drive out the air and thus prevent the formation of a bubble between the membrane and the cellulose pad placed on the plate, which ensures for the operator a good marking or revealing of the membrane by the material soaking the cellulose.

In any event, the operator does not need to ask the question as to whether or not he has performed the correct action, since the means that equip the plate guide him and enable him to perform only the required action. When the operation has been performed, the membrane 3 occupies the position shown in broken lines in FIG. 10. Once this operation has been performed, it then suffices to leave the membrane 3 to incubate on its support plate 5 within an enclosure provided for this purpose, for a time and temperature specific to the protocol to be implemented.

To separate the membrane 3 from the plate 5, a downwardly directed force (in the direction of the arrow q in FIG. 9) is exerted on the appendage 53. This causes breakage thereof at the weakening zone 530, or at the very least tilting thereof, in the direction of the arrow r, with respect to the plate 5. By virtue of this movement, the lug 7 disengages from the membrane 3, so that it is possible to proceed with the removal of the latter. Naturally, if the membrane is to be the subject of other test operations, it will be removed with the cap 4 described above.

1-11. (canceled)

12. An assembly comprising a flat rigid filtration membrane, and a roughly flat plate, operably receiving and supporting this membrane to activate and/or reveal contaminants immobilised thereon; the support plate comprising a holding and immobilisation device cooperating with a periphery of the membrane, wherein the device comprises at least one non-deformable member that projects above the overall plane of the plate, and at least one tab forming a stop, substantially perpendicular to the plane, which is extended by a holding appendage substantially parallel to the plane, so that the membrane can be engaged with the member only in a first movement of the membrane substantially parallel to the plane of the plate, followed by a second movement substantially perpendicular to the plane.

13. The assembly according to claim 12, further comprising at least one additional member forming a locking member, which also projects above the overall plane of the plate, the additional member being elastically deformable, so that, at the time of the second movement, it retracts and then resumes its initial position, thus locking the membrane.

14. The assembly according to claim 13, wherein the non-deformable member is situated opposite and facing the second member.

15. The assembly according to claim 12, wherein the membrane is provided with a lug adapted to cooperate with the non-deformable member.

16. The assembly according to claim 15, wherein the lug is, seen from above, in the general shape of a “T”.

17. The assembly according to claim 13, wherein the membrane is provided with a lug adapted to engage with the second member.

18. The assembly according to claim 17, wherein the lug is, as seen from above, in the general shape of one of: a Latin or Greek cross.

19. The assembly according to claim 15, wherein the membrane fits in a circle, the lug extending radially, at the periphery of this circle.

20. The assembly according to claim 13, wherein the plate comprises a region that supports the second member and is separated from the rest of the plate by a mechanical weakening zone, so that, following a mechanical force exerted on this region, it is given a particular orientation with respect to the rest of the plate, which makes it possible to release the membrane from the second member.

21. The assembly according to claim 20, wherein the region forms an appendage with respect to the rest of the plate, the weakening zone being situated at their boundary.

22. The assembly according to claim 12, wherein the plate comprises, in its central part, a recess adapted to accept a material able to interact with the membrane.

23. A filtration assembly comprising:
a porous membrane fixedly retained within a rigid frame adapted to collect contaminants in a liquid, wherein the rigid frame has a first lug and a second lug located diametrically opposite on an outer diameter of the rigid frame;
a plate receiving the membrane;
a plurality of tabs extending substantially perpendicular to a plane of the plate for fixing the rigid frame to the plate, wherein at least one of the plurality of tabs is stationary;
a panel located substantially parallel to the plane of the plate, the panel having a first face and an opposite second face; and
a locking member extending from the panel and being substantially perpendicular to the plane of the plate,
the rigid frame being locked into a fixed position on the plate when the first lug of the rigid frame is engaged with the stationary tab and the second lug of the rigid frame is engaged with the locking member.

24. The filtration assembly according to claim 23, further comprising a first movement engaging the first lug with the stationary tab, the first movement comprising moving the membrane in a direction substantially parallel to the plane of the plate and inserting the first lug between the plate and the stationary tab.

25. The filtration assembly according to claim 23, further comprising a second movement engaging the second lug with the locking member and fixing the rigid frame to the plate, the second movement comprising moving the membrane in a direction perpendicular to the plane of the plate and engaging the second lug with the locking member.

26. The filtration assembly according to claim 23, wherein the second lug is engaged with the locking member when a compressive force is applied to the first face of the panel substantially perpendicularly moving the panel from an original position and increasing a distance between the locking member and the stationary tab.

27. The filtration assembly according to claim 26, wherein the rigid frame is locked into a fixed position on the plate when the compressive force is removed and the panel returns to the original position.

28. The filtration assembly according to claim 23, wherein the first lug has a trunk extending in the radial direction and a curved transverse bar extending substantially perpendicular to the trunk.

29. The filtration assembly according to claim 23, wherein the second lug has a radial trunk and a curved transverse branch, and the radial trunk extends beyond an outside diameter of the transverse branch.

30. The filtration assembly according to claim 23, further comprising a wall substantially perpendicular to the plane of the plate defining a recess in the center of the plate that is adapted to accept a material compatible to interact with the membrane.

31. A filtration assembly comprising:
a receptacle operably receiving a liquid;
a base removably attached to the receptacle;
a substantially flat filtration membrane removably attached to the base that operably filters the liquid;
a rigid frame being of cylindrical shape and supporting an outer edge of the filtration membrane;
a porous membrane irremovably attached within the rigid frame that operably retains contaminants from the liquid passing through the filtration membrane;
a plurality of locators opposed on the rigid frame positioned on the same plane as the rigid frame that locate the filtration membrane onto the base,
the first locator having a trunk extending in the radial direction and a transverse bar extending substantially perpendicular to the trunk, wherein the transverse bar is curved,
the second locator having a radial trunk and a transverse branch, wherein the radial trunk extends beyond the transverse branch;
a circular support plate having a first face and an opposite second face that receives the filtration membrane;
a region of the support plate in the same plane as the support plate that releases the filtration membrane from the support plate, wherein the filtration membrane is released by applying compressive force on the first face of the region;
a non-deformable member positioned diametrically opposite the region having a tab and a hook that secures the filtration membrane to the support plate;
a first movement engaging the first locator and the non-deformable member;
a locking member positioned diametrically opposite the non-deformable member and having a foot and a locking finger that retains the filtration membrane;
a second movement engaging the second locator and the locking member to fix the filtration membrane to the plate;
a notch in the region defining a weakening line that deforms when compressive force is applied to the top face of the region, wherein a distance between the non-deformable member and the locking member is increased when the compressive force is applied,
a cylindrical wall positioned on the first face of the support plate supporting the filtration membrane and defining a recess in the center of the support plate adapted to accept a material to interact with the porous membrane, wherein a diameter of the cylindrical wall corresponds to an inside diameter of the rigid frame; and
a plurality of studs positioned in the recess of the support plate supporting the filtration membrane.
